(19) United States
(12) Patent Application Publication
(10) Pub. No.: US 2026/0008415 A1
(43) Pub. Date: Jan. 8, 2026

(54) METHOD FOR MONITORING A SPACE TO THE REAR AND/OR A SPACE TO THE SIDES FOR A MULTIPLE-UNIT VEHICLE COMBINATION, COMPUTER PROGRAM AND/OR COMPUTER-READABLE MEDIUM, CONTROL DEVICE, TRAILER, TRACTOR VEHICLE AND MULTIPLE-UNIT VEHICLE COMBINATION

(71) Applicant: ZF CV Systems Global GmbH, Bern (CH)

(72) Inventors: Axel Stender, Hameln (DE); Andreas Goers, Pattensen (DE); Jan-Christoph von der Beeke, Algermissen (DE); Andelko Glavinic, Sarstedt (DE); Bernd Meuerer, Greven (DE)

(21) Appl. No.: 19/329,180

(22) Filed: Sep. 15, 2025

Related U.S. Application Data
(63) Continuation of application No. PCT/EP2024/053528, filed on Feb. 13, 2024.

(30) Foreign Application Priority Data
Mar. 13, 2023 (DE) 10 2023 106 124.0

(51) Int. Cl. B60R 1/23; B60K 35/28; B60K 35/29; B60R 1/00

(52) U.S. Cl. CPC B60R 1/23; B60K 35/28; B60K 35/29; B60R 1/002

(57) ABSTRACT

A method is for monitoring a space to the rear and/or a space to the sides for a multiple-unit vehicle combination having a trailer which has a camera arranged in a front region of the trailer for monitoring the space to the rear and/or the space to the sides, and a tractor vehicle having a mirror replacement system. The method includes: acquiring visibility information relating to the visibility of the trailer, of the space to the rear and/or of the space to the sides; determining display information on the basis of the visibility information; and, outputting a control signal for outputting image data from the camera on an output device on the basis of the display information.

### CROSS-REFERENCE TO RELATED APPLICATIONS

This application is a continuation application of international patent application PCT/EP2024/053528, filed Feb. 13, 2024, designating the United States and claiming priority from German application 10 2023 106 124.0, filed Mar. 13, 2023, and the entire content of both applications is incorporated herein by reference.

### TECHNICAL FIELD

The disclosure relates to a method for monitoring a rear space and/or a lateral space for a multiple-unit vehicle combination, in particular a utility vehicle combination, including a trailer with a camera mounted in a front area of the trailer for monitoring the rear space and/or the lateral space and a tractor vehicle with a mirror replacement system. The disclosure also relates to a computer program and/or a computer-readable medium, a control device for a multiple-unit vehicle combination, in particular a utility vehicle combination, including a trailer with a camera arranged in a front area of the trailer for monitoring a rear space and/or a lateral space and a tractor vehicle, for monitoring the rear space and/or the lateral space, a trailer for a multiple-unit vehicle combination, in particular a utility vehicle combination, including the trailer and a tractor vehicle with a camera for monitoring a rear space and/or a lateral space, a tractor vehicle for a multiple-unit vehicle combination, in particular a utility vehicle combination, including such a trailer and the tractor vehicle and a multiple-unit vehicle combination, in particular a utility vehicle combination.

### BACKGROUND

The monitoring of a lateral space and/or rear space of the multiple-unit vehicle combination, in particular a utility vehicle combination, is a safety feature for the vehicle combination, in particular a utility vehicle combination, which facilitates reversing with the vehicle combination, in particular a utility vehicle combination. Monitoring the lateral and/or rear space can reduce the risk of damage and/or accidents due to the driver's lack of visibility of the lateral space and/or the rear space.

A reversing information system, RelS, or a reversing assistant system according to the General Safety Regulation, GSR, (REGULATION (EU) 2019/2144 OF THE EUROPEAN PARLIAMENT AND OF THE COUNCIL of Nov. 27, 2019) requires either a camera image from a rear-facing camera or a detecting and warning system. Camera images are preferred over other assistance systems by drivers because a visual assessment of the situation gives a driver more options for action.

Camera arrangements for vehicles are known from the prior art.

For example, so-called surround view systems are known. Such a surround view system can monitor the entire environment of the rear part of the vehicle, such as the trailer. Both a composite overall image and individual images that can be switched depending on the driving situation can be provided. However, a central display is required for such a surround view system. On the other hand, drivers are used to the use of rear-view mirrors or mirror replacement systems, the monitors of which are usually arranged near a corresponding A-pillar. In order to display image data from the surround view system simultaneously, “stitching” is carried out, that is, the stitching together of image data from several cameras. However, the “stitched” view of a surround view system takes some getting used to. It takes practice and experience to interpret such a “stitched” representation. Furthermore, the capture area of the surround view system is not standardized. When changing a trailer and thus cameras, different viewing angles can be confusing. Ultimately, it is possible that danger spots may not be correctly identified due to the unfamiliar presentation and the presentation principle.

In addition to surround view systems, other side-mounted sensors such as ultrasonic sensors and/or radars may also be suitable for generating warnings of maneuvering damage.

U.S. Pat. No. 5,027,200 discloses a device which permits the observation of traffic or other conditions behind and to the side of a motor vehicle with opposite sides. The device contains a video camera structure mounted on the vehicle and directed laterally relative to the vehicle, and a CRT structure (cathode-ray tube structure) operationally connected to the camera structure to display a camera output on a CRT screen zone or zones, wherein the CRT screen zone or zones is/are visible to the driver, to enhance viewing of the rear and side of the vehicle.

DE 10 2008 039 649 A1 discloses an environment detection device for observing the environment of a multiple-unit vehicle. The environment detection device contains at least one camera that can be arranged on a rear vehicle element, a display unit arranged in a front vehicle element for displaying images captured via the at least one camera, and a mobile quick-attachment device for attaching the at least one camera to different rear vehicle elements. An automatic image switching system is provided, which selects the camera on the blind spot side of the multiple-unit vehicle when reversing. This means that the blind spot area is advantageously displayed to the driver when reversing, especially when maneuvering. The display unit is in the form of a screen in the driver cab that can be viewed by the driver.

Also, according to the prior art, “stitching” and/or a central display is used to enable the driver to monitor a lateral space and/or a rear space.

### SUMMARY

It is an object of the disclosure to provide improved monitoring of a lateral space and/or a rear space. In particular, an embodiment of the disclosure can achieve the object of enabling safer monitoring of a lateral space and/or a rear space and providing a representation for monitoring the lateral and/or rear space in a way that is intuitively accessible to the user.

The object is achieved by various embodiments of the disclosure.

According to an aspect of the disclosure, a method for monitoring a rear space and/or a lateral space for a multiple-unit vehicle combination, in particular a utility vehicle combination, is provided. The vehicle combination includes a trailer with a camera arranged in a front area of the trailer for monitoring the rear space and/or the lateral space of the trailer and a tractor vehicle with a mirror replacement system. Here the method includes: capturing recognizability information relating to the recognizability of the trailer, the rear space, and/or the lateral space; determining display information based on the recognizability information; and outputting a control signal to output image data from the camera to an output device of the tractor vehicle based on the display information.

The vehicle combination, in particular the utility vehicle combination, is referred to here and in the following as the vehicle combination. The vehicle combination is multiple-unit and has the trailer and the tractor vehicle.

The tractor vehicle has the mirror replacement system and the output device. The driver of the vehicle combination is accustomed to using the mirror replacement system instead of a mirror and/or in addition to a mirror to monitor a lateral space and/or a rear space of the tractor vehicle. For this purpose, the output device is set up to display an output that is visually perceptible to the driver of the vehicle combination.

The trailer has the front area. The front area is a section of the trailer that is closer to the tractor vehicle than the rear space, for example, if the tractor vehicle and the trailer form the multiple-unit vehicle combination. The camera is arranged in the front area to monitor the rear space and/or the lateral space of the trailer. The camera is set up to capture image data relating to the rear space and/or the lateral space.

In order to be able to display image data from the camera to the driver of the vehicle combination suitably, the recognizability information is captured. In this context, the recognizability information may relate to the recognizability of the trailer, the rear space, and/or the lateral space in relation to the user and/or the mirror replacement system. It was recognized that the recognizability of the trailer¬by, for example, the mirror replacement system means that sections of the lateral space and/or the rear space are concealed by the trailer and thus cannot be detected by the mirror replacement system.

The display information is determined on the basis of the recognizability information. To determine the display information, the recognizability information is evaluated. The display information can be used to determine which image data are to be output by the output device and how. With the mirror replacement system, the image of the camera of the trailer can be made available once, for example, the rear end of the trailer can no longer be recognized in the mirror replacement system.

Based on the display information, the control signal for outputting image data from the camera is output to the output device of the mirror replacement system. The control signal causes the image data captured by the camera to be displayed on the output device. The driver can optionally perceive the image data at a location that is familiar to him, wherein the image data show a familiar perspective of the lateral space and/or the rear space.

The disclosure provides the effect that the camera in the front area of the trailer, with a “direction of view” or a detection area, works like a camera-based mirror replacement system and can be arranged at the level of the front wall of the trailer and aligned along the trailer, that is, rearwards. This means that the camera has the same viewing direction that the driver knows from a prescribed mirror or an approved mirror replacement system. The perspective is intuitively accessible to the driver. In particular, if a swerve of the trailer prevents a view of a lateral end of the trailer, the view of the camera mounted on the trailer can be displayed in the tractor vehicle by the display device. The camera of the trailer can therefore be described as an extension of the “mirror view”.

Optionally, the recognizability information includes an articulation angle. Alternatively or additionally, the recognizability information includes movement data relating to the movement of the tractor vehicle in order to determine the articulation angle. The articulation angle refers to an angle that is included between the direction of travel of the tractor vehicle or the longitudinal axis of the tractor vehicle and the longitudinal axis of the trailer. It was recognized that the articulation angle has a decisive influence on the visibility of the lateral space and/or the rear space. As the angle of articulation increases, the view of the user and/or the capture area of the mirror replacement system may be increasingly obscured by the trailer and, in particular, by the trailer front facing the tractor vehicle. It was also recognized that the articulation angle can be measured directly via a sensor, for example, and can thus be detected effectively. Alternatively or additionally, the articulation angle can be calculated or determined on the basis of the movement data. The articulation angle, which leads to non-visible areas in the lateral space and/or the rear space of the trailer, can be deduced from the movement of the vehicle, in particular the steering wheel angle and the speed.

Optionally, the display information is determined depending on a predetermined condition relating to the articulation angle. It was recognized that switching from the mirror replacement system to the trailer camera can take place once the articulation angle between the tractor vehicle and the trailer exceeds a certain value. The predetermined condition can include the value of the articulation angle and a comparison of the measured articulation angle with the value.

Optionally, the recognizability information includes mirror replacement image data collected by the mirror replacement system. The recognizability information may include the fact that the mirror replacement system makes a front face of the trailer recognizable and thus the end of the trailer is obscured. The recognizability information can be effectively determined, for example, by object recognition in the mirror replacement image data.

Optionally, the display information is determined depending on whether a front face of the trailer and/or which front section of the front face is depicted in the mirror replacement image data. This makes it possible, for example, to monitor a section of the lateral space and/or rear space that lies to the right or left in the direction of travel in a differentiated manner.

According to another aspect of the disclosure, a computer program and/or a computer-readable medium is provided. The computer program and/or the computer-readable medium contain instructions that, during execution of the program or instructions by a computer, cause the computer to carry out the method described herein and/or the steps of the method described herein. The computer program and/or the computer-readable medium may include instructions to perform a step of the method described as optional in order to achieve a corresponding technical effect.

According to an aspect of the disclosure, a control device for a multiple-unit vehicle combination, in particular a utility vehicle combination, containing a trailer with a camera arranged in a front area of the trailer for monitoring a rear space and/or a lateral space, is provided for monitoring the rear space and/or the lateral space. The control device is set up to carry out the method described above. The control device may be set up to carry out a step of the method described as optional in order to achieve a corresponding technical effect.

Optionally, the control device is a control device of the tractor vehicle. This means that the control device of the tractor vehicle is set up to carry out the method described above. Thus, a powerful control device for the trailer is unnecessary. It may therefore be sufficient for the trailer to have a data processing device that provides an interface to the control device. The data processing device is set up to transmit image data to the tractor vehicle. For example, the control device can request the capture of image data by the camera via a control signal. Alternatively, the control device can also receive image data without a request of the control device of the tractor vehicle. The trailer can also continuously send the camera data or image data to the tractor vehicle without a request from the control device of the tractor vehicle.

According to an aspect of the disclosure, a trailer for a multiple-unit vehicle combination, in particular a utility vehicle combination, including the trailer and a tractor vehicle is provided with a camera arranged in a front area of the trailer for monitoring a rear space and/or a lateral space. The trailer has a data processing device for transmitting image data to the tractor vehicle and the data processing device is set up to receive a control signal from the tractor vehicle for the output of image data from the camera to an output device. Furthermore, it is disclosed that the trailer is configured to continuously transmit image data to the tractor vehicle without receiving a control signal, wherein the tractor vehicle is set up to carry out all display controls.

The trailer is thus set up to provide the camera to carry out the method described above. The trailer may have two cameras, wherein a first of the two cameras is arranged and set up for monitoring a left lateral space and a second of the two cameras is arranged and set up for monitoring a right lateral space. The trailer may have a reversing camera for monitoring the rear space.

According to an aspect of the disclosure, a tractor vehicle is provided for a multiple-unit vehicle combination, in particular a utility vehicle combination, including the trailer and the tractor vehicle described above. The tractor vehicle has the control device described above and a mirror replacement system with an output device.

This means that the tractor vehicle is set up to carry out the method described above. The mirror replacement system may have two mirror replacement cameras, wherein a first of the two mirror replacement cameras is arranged and set up for monitoring a left lateral space and a second of the two mirror-replacement cameras is arranged and set up for monitoring a right lateral space. The mirror replacement system may have two mirror replacement output devices, wherein one of the two mirror replacement output devices is set up to output mirror replacement image data from the first mirror replacement camera and a second of the two mirror replacement output devices is set up to output mirror replacement image data from the second mirror replacement camera.

Optionally, the mirror replacement system has a mirror replacement output device, and the output device is different from the mirror replacement output device. In other words, an additional output device can be provided in this embodiment. The output device can be arranged near the mirror replacement output device. The output device may be provided exclusively for the image data of the trailer camera and may not affect the mirror replacement system. This means that legal requirements relating to the mirror replacement system can be complied with.

Optionally, the mirror replacement system has a mirror replacement output device and the output device contains the mirror replacement output device. In other words, the image data from the camera of the trailer and/or the mirror replacement image data can be displayed on a common output device or mirror replacement output device. Thus a separate output device to output the image data from the trailer camera is unnecessary.

Optionally, the output device is set up to simultaneously output image data from the camera and from a reversing camera. In other words, the output device can be used for the image data of the camera of the trailer and for the image data of the reversing camera (split-screen). This means that the entire rear space, which is otherwise not visible, is displayed in a way that the driver is used to. For example, a monitor on a right A-pillar in the upper monitor area represents the right side of the trailer. The video of the reversing camera is displayed in the lower monitor area. A monitor on a left A-pillar represents the left side of the trailer in the upper monitor area. The video of the reversing camera is displayed in the lower monitor area.

Optionally, the control device is set up to blend the image data from the camera and the mirror replacement image data. For example, if the use of the mirror replacement output device is permitted for blending with the image data from the camera of the trailer, mirror replacement image data and image data from the camera of the trailer may be monitored simultaneously to prevent damage that may be caused, for example, by a protruding trailer end face.

According to an aspect of the disclosure, a multiple-unit vehicle combination, in particular a utility vehicle combination, is provided. The vehicle combination, in particular the utility vehicle combination, includes the tractor vehicle described above and the trailer described above.

Optionally, the multiple-unit vehicle combination, in particular the utility vehicle combination, contains a communication interface for the transmission of information between the control device of the tractor vehicle and the data processing device of the trailer. The communication interface can be used to control the camera and/or transmit the image data. Optionally, a transfer of image data from several cameras can be carried out via a common, especially standardized, data line, which simplifies cabling between the cameras and the tractor vehicle and avoids compatibility problems between the tractor vehicle (truck) and the trailer. Standardized service functions of the camera can be provided, which the tractor vehicle can request if necessary.

### BRIEF DESCRIPTION OF DRAWINGS

The invention will now be described with reference to the drawings wherein:

FIG. 1 shows a multiple-unit vehicle combination, in particular a utility vehicle combination, according to the prior art with a typical arrangement of damage;

FIG. 2 shows a multiple-unit vehicle combination, in particular a utility vehicle combination, according to the prior art when driving in a straight line;

FIG. 3 shows a multiple-unit vehicle combination, in particular a utility vehicle combination, according to the prior art when cornering;

FIG. 4 shows a multiple-unit vehicle combination, in particular a utility vehicle combination, according to the prior art when driving in a straight line;

FIG. 5 shows a multiple-unit vehicle combination, in particular a utility vehicle combination, according to the prior art when cornering;

FIG. 6 shows a multiple-unit vehicle combination, in particular a utility vehicle combination, according to the prior art when cornering;

FIG. 7 shows a multiple-unit vehicle combination, in particular a utility vehicle combination, according to an aspect of the disclosure when cornering;

FIG. 8 shows a schematic representation of a multiple-unit vehicle combination, in particular a utility vehicle combination, according to one aspect of the disclosure;

FIG. 9 shows a schematic representation of a multiple-unit vehicle combination, in particular a utility vehicle combination, according to an aspect of the disclosure; and,

FIG. 10 shows a schematic sequence of a method according to an aspect of the disclosure.

### DETAILED DESCRIPTION

With reference to the figures described below, the multiple-unit vehicle combination 200a, in particular the utility vehicle combination 200b, is also referred to as a vehicle combination 200a, 200b. Such a vehicle combination 200a, 200b has a tractor vehicle 240 and a trailer 250.

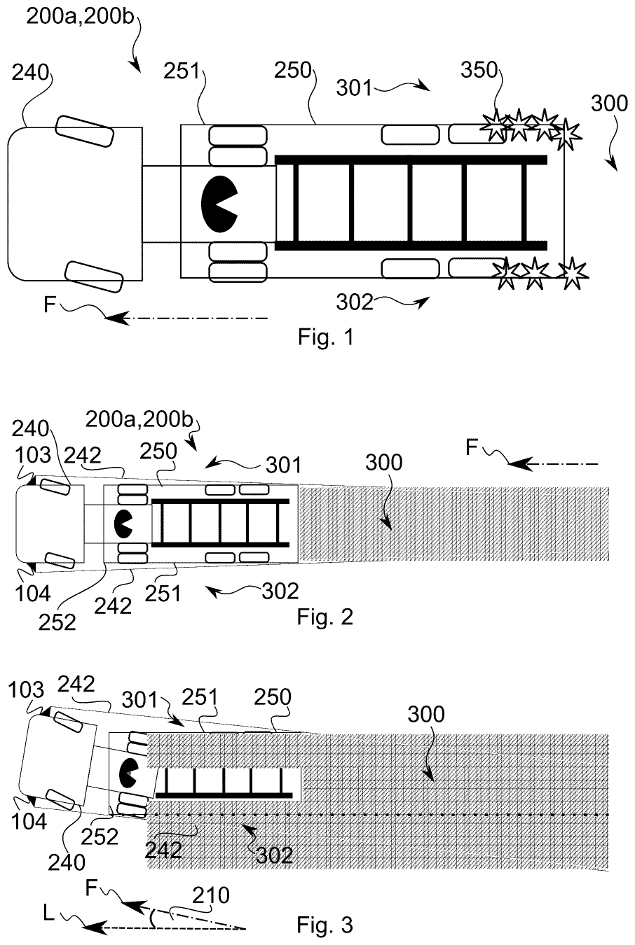

FIG. 1 shows a multiple-unit vehicle combination 200a, in particular a utility vehicle combination 200b, according to the prior art with a typical arrangement of damage 350.

Damage analyses of vehicle combinations 200a, 200b according to the prior art show an accumulation of damage 350 at the end of the attached vehicle or trailer 250. This shows that increased damage 350 can also be observed on the sides of the trailer 250. The damage 350 shown in FIG. 1 occurs in places which, as described with reference to FIGS. 2 to 5, are not visible during maneuvering and especially when reversing with a steering system of the vehicle combination 200a, 200b.

FIG. 2 shows a multiple-unit vehicle combination 200, in particular a utility vehicle combination 200b, according to the prior art when driving straight ahead.

The tractor vehicle 240 has two mirror replacement cameras 103, 104. One of the mirror replacement cameras 103 is arranged on the left in the direction of travel F. The other of the mirror replacement cameras 104 is arranged on the right in the direction of travel F. Each of the mirror replacement cameras 103 is oriented opposite to the direction of travel F and thus has an observation area 242 starting from the respective mirror replacement camera 103, 104 towards a rear space 300. Due to the arrangement of the mirror replacement cameras 103, 104, a lateral space 301, 302 is arranged in the observation area 242. The lateral space 301, 302 includes the trailer 250 or a body 251 of the trailer 250.

When reversing in a straight line, the rear space 300 of the trailer 250 is not visible as shown by the hatched area, that is, the rear space 300 is not in the observation area 242 and a view of the rear space 300 is obscured by the trailer 250. Damage 350 (not marked) in this area can therefore be explained. To prevent damage 350, sensor systems can be provided that can warn of objects and can even trigger a braking intervention in the braking system of the trailer 250.

FIG. 3 shows a multiple-unit vehicle combination 200a, in particular a utility vehicle combination 200b, according to the prior art when cornering. FIG. 3 is described with reference to FIG. 2.

In FIG. 3, the tractor vehicle 240 has a direction of travel F. The direction of travel F corresponds to a longitudinal axis of the tractor vehicle 240. The direction of travel F is different from a longitudinal axis L of the trailer 250. This means that the vehicle combination 200a, 200b has an articulation angle 210. The articulation angle 210 describes the difference between the orientation of the direction of travel F, that is, the longitudinal axis of the tractor vehicle 240, and the longitudinal axis L of the trailer 250.

The articulation angle 210 changes the non-visible area of the lateral space 301, 302 and/or the rear space 300 illustrated by the hatching. On the right-hand side of the tractor vehicle 240 in the direction of travel F, the right-hand lateral space 301 and the right-hand side of the trailer 240 can be detected by the mirror replacement camera 103. However, a front face 252 of the body 251 of the trailer 250 arranged in the direction of travel F covers the unobstructed view of the left-hand lateral area 302, as shown by a dotted line within the hatched area.

Thus, damage 350 (not shown in FIG. 3) on the sides of the trailer 250 that occurs during maneuvering can be explained by areas that are not visible due to the articulation angle 210 between the tractor vehicle 240 and the trailer 250.

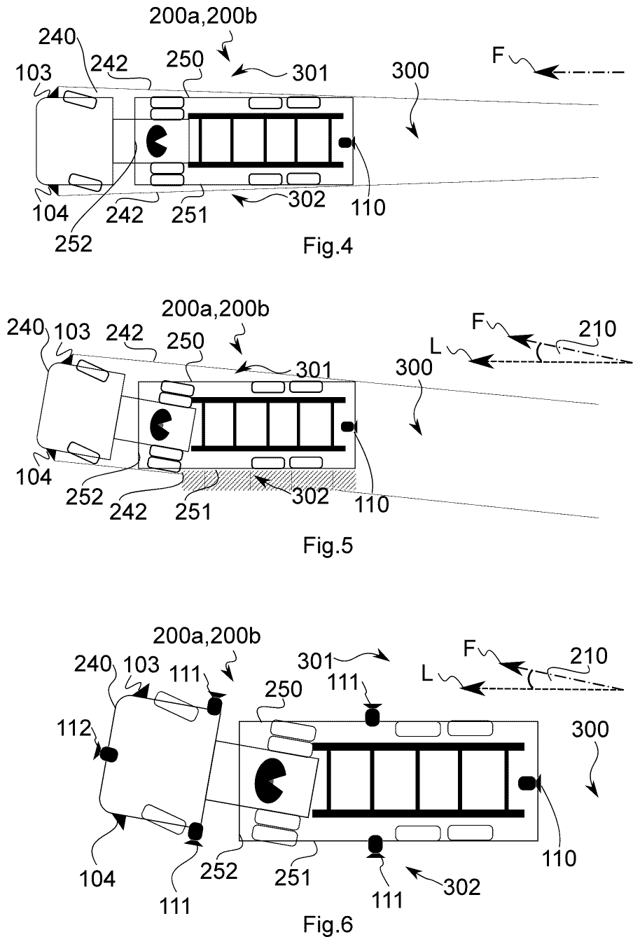

FIG. 4 shows a multiple-unit vehicle combination 200a, in particular a utility vehicle combination 200b, according to the prior art when driving in a straight line.

The vehicle combination 200a, 200b has a reversing camera 110 for monitoring the rear space 300. This means that the rear space 300 can be made available to both the driver and an automated system, especially with a wide-angle lens. Data are transmitted to the tractor vehicle 240 via an interface for the digital data transmission of image data and/or video data and are fed into a display and/or evaluation.

FIG. 5 shows a multiple-unit vehicle combination 200a, in particular a utility vehicle combination 200b, according to the prior art when cornering. FIG. 5 shows the situation described with reference to FIG. 3, wherein the vehicle combination 200a, 200b has the reversing camera 110 as described with reference to FIG. 4. However, the centrally mounted reversing camera 110 does not fully allow monitoring of the lateral space 301, 302 as illustrated by the hatched area.

FIG. 6 shows a multiple-unit vehicle combination 200a, in particular a utility vehicle combination 200b, according to the prior art when cornering. The vehicle combination 200a, 200b has a plurality of side cameras 111 and a reversing camera 110. The vehicle combination 200a, 200b thus provides a surround view system. This allows the lateral space 301, 302 and the rear space 300 to be monitored, but in a way that is not intuitively accessible to the user.

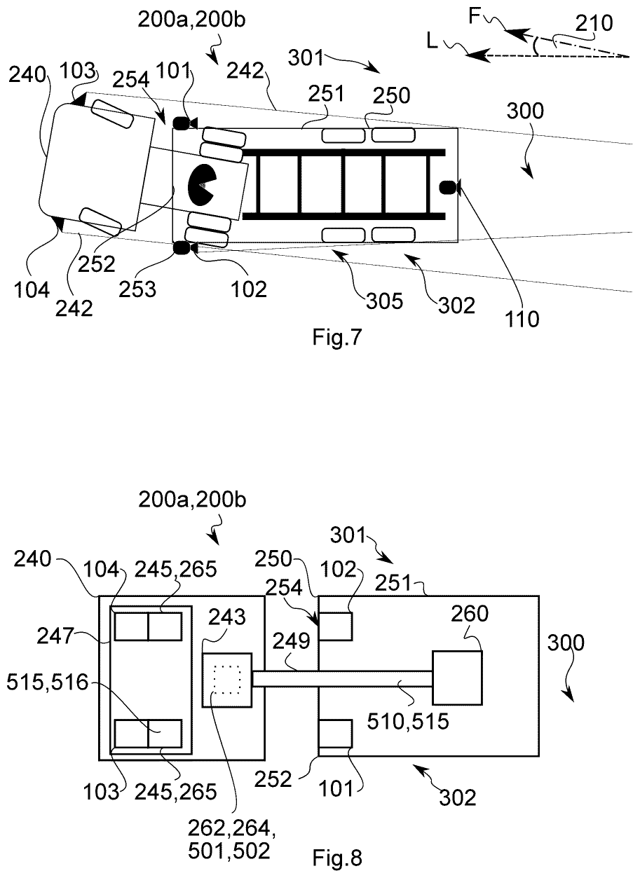

FIG. 7 shows a multiple-unit vehicle combination 300a, in particular a utility vehicle combination 300b, according to an aspect of the disclosure when cornering.

The vehicle combination 200a, 200b includes a tractor vehicle 240 and a trailer 250. The tractor vehicle 240 contains a cab from which a driver (not shown) can operate the vehicle combination 200a, 200b.

The tractor vehicle 240 is characterized by a forward direction of travel when driving in a straight line, which is hereinafter referred to as the direction of travel F. The direction of travel F corresponds to a longitudinal axis of the tractor vehicle 240. The tractor vehicle 240 is set up to drive opposite to the direction of travel F, that is, backwards, for maneuvering, for example.

The trailer 250 is defined by a longitudinal axis L. The longitudinal axis L corresponds to the forward direction of the trailer 250 when driving straight ahead.

Steering the tractor vehicle 240 can lead to an articulation angle 210. The articulation angle 210 results from a difference between the direction of travel F and the longitudinal axis L. The articulation angle 210 is measured by an articulation angle measurement sensor (not shown) of the tractor vehicle 240 and/or of the trailer 250.

The surroundings of the vehicle combination 200a, 200b include a lateral space 301, 302 and a rear space 300. In this context, the lateral space 301, 302 in relation to the direction of travel F contains a right lateral space 301 and a left lateral space 302. The lateral space 301, 302 refers to a section of the surroundings of the vehicle combination 200a, 200b which is arranged laterally, that is, to the left or right, of the tractor vehicle 240 and the trailer 250. The rear space 300 refers to a section of the surroundings of the vehicle combination 200a, 200b which is arranged behind the trailer 250 in relation to the longitudinal direction L.

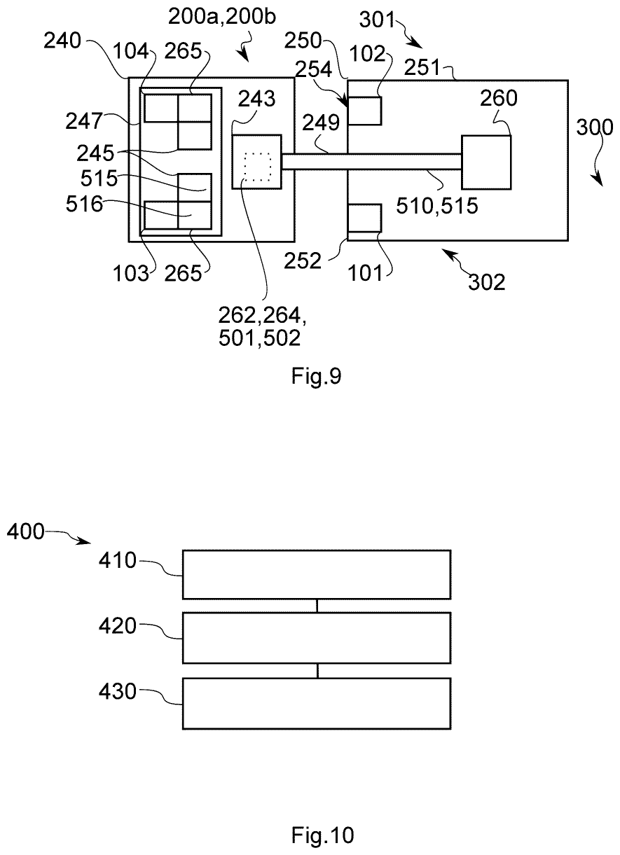

The tractor vehicle 240 contains a mirror replacement system 247 (shown in FIGS. 8 and 9) with a right mirror replacement camera 103 arranged on the right in the direction of travel F and a left mirror replacement camera 104 arranged on the left in the direction of travel F. Each of the mirror replacement cameras 103, 104 has an observation area 242, the boundary of which is illustrated by a dotted line. The mirror replacement cameras 103, 104 are oriented opposite to the direction of travel F in order to monitor the trailer 250 or the lateral space 301, 302 and/or the rear space 300.

The trailer 250 has a body 251. The body 251 can be set up for transporting goods. The trailer 250 has a front area 254. The front area 254 is a section of the trailer 250 which is arranged at the front face of the trailer 250 in relation to the longitudinal direction L, that is, closer to the tractor vehicle 240 than to the rear space 300.

The body 251 has a front face 252 arranged frontally in relation to the longitudinal direction L. If the vehicle combination 200a, 200b has an articulation angle 210, the front face 252 can protrude into the observation area 242 of the mirror replacement cameras 103, 104 with a front face section 253. Thus, the trailer 250 covers the observation area 242 for monitoring the lateral space 301, 302 and/or the rear space 300 by the or one of the mirror replacement cameras 103, 104.

The trailer 250 has two cameras 101, 102 arranged in the front area 254 of the trailer 250 for monitoring the rear space 300 and/or the lateral space 301, 302. In another embodiment that is not shown, the trailer 250 can have exactly one or more than two such cameras. The cameras 101, 102 in the embodiment according to FIG. 7 include a camera 102 arranged on the left in the longitudinal direction L for monitoring the left lateral space 302 and/or the rear space 300 and a camera 101 arranged on the right for monitoring the right lateral space 301 and/or the rear space 300. The cameras 101, 102 are oriented opposite to the longitudinal direction L to monitor the trailer 250 or the lateral space 301, 302 and/or the rear space 300. This means that each of the cameras 101, 102 has a detection area 305. The detection area 305 of the left camera 102 corresponds to the observation area 242 of the left mirror replacement camera 104 if the trailer 240 were not obscuring the observation area 242.

The trailer 250 has a reversing camera 110 arranged in a rear section of the trailer 250 for monitoring the rear space 300.

In particular, the cameras 101, 102 and the reversing camera 110 can be high-resolution cameras in order to be able to zoom in on areas of particular interest.

The image data 515 are displayed in one embodiment when reversing and when driving forward only in situations where the rear end of the trailer 250 is obscured. Alternatively, the image data 515 are only displayed in situations where the rear end of the trailer 250 is obscured.

The vehicle combination 200a, 200b is further described below with reference to FIGS. 8 and 9.

FIG. 8 shows a schematic representation of a multiple-unit vehicle combination 200a, in particular a utility vehicle combination 200b, according to one aspect of the disclosure. FIG. 8 shows an embodiment of the vehicle combination 200a, 200b shown in FIG. 7. FIG. 8 is described with reference to FIG. 7.

The vehicle combination 200a, 200b is set up to carry out the method 400 described with reference to FIG. 10. For this purpose, the tractor vehicle 240 according to FIG. 8 has a control device 243. The trailer 250 has a data processing device 260.

The control device 243 is set up to capture recognizability information 501. The recognizability information 501 relates to recognizability by the mirror replacement system 247 of the trailer 250, the rear space 300 and/or the lateral space 301, 302. Thus, the recognizability information 501 indicates whether the trailer 250, the rear space 300 and/or the lateral space 301, 302 is arranged in the observation area 242 of the mirror replacement system 247. The recognizability information 501 may also indicate which parts of the trailer 250, the rear space 300 and/or the lateral space 301, 302 are arranged in the observation area 242 of the mirror replacement system 247. The recognizability information 501 includes the articulation angle 210 and/or movement data 264 relating to a movement of the tractor vehicle 240 for the determination of the articulation angle 210. For this purpose, the control device 243 can be connected to an articulation angle sensor and/or may gather information about a steering angle and speed of the vehicle combination 200a, 200b via a CAN bus in order to determine the articulation angle 210. The recognizability information 501 also includes mirror replacement image data 516 recorded by the mirror replacement system 247, from which, for example, coverage of the lateral space 301, 302 and/or the rear space 300 can be determined by object recognition.

The control device 243 is set up to determine display information 502 on the basis of the recognizability information 501. The display information 502 indicates which image data 515 by one of the cameras 101, 102 are requested and/or are to be output by the output device 245. The display information 502 is determined depending on a predetermined condition 262 concerning the articulation angle 210. The predetermined condition 262 can include a threshold value for the articulation angle 210 or the magnitude, that is, an absolute value, of the articulation angle 210, from which image data 515 of one or more of the cameras 101, 102 are to be output. The predetermined condition 262 can also take into account the orientation of the articulation angle 210 in order to be able to switch between image data 515 of the cameras 101, 102. The display information 502 can be determined additionally or alternatively depending on whether the front face 252 of the trailer 250 and/or which front face section 253 of the front face 252 is depicted in the mirror replacement image data 516. An illustration of the front face 252 and/or the front face section 253 indicates obscuring of the observation area 242 of the mirror replacement system 247.

The control device 243 is set up to output a control signal 510 for the output of image data 515 from the camera 101, 102 to the output device 245 on the basis of the display information 502. For this purpose, the vehicle combination 200a, 200b contains a communication interface 249 for the transmission of information between the control device 243 of the tractor vehicle 240 and the data processing device 260 of the trailer 250. The data processing device 260 is set up to receive, via the communication interface 249, the control signal 510 from the tractor vehicle 240 for the output of image data 515 from the camera 101, 102 to an output device 245 on the basis of the display information 502. The data processing device 260 can be used as a driver for the cameras 101, 102, that is, the control signal 510 includes a request for certain image data 515 from at least one of the cameras 101, 102. Accordingly, the image data 515 are transmitted to the tractor vehicle 240 via the communication interface 249. Alternatively, the data processing device 260 can actively intervene to determine which image data 515 are sent to the tractor vehicle 240.

The control device 243 is set up to perform blending of the image data 515 from the camera 101, 102 and mirror replacement image data 516. The blending may depend in particular on the articulation angle 210 and/or on obscuring of the observation area 242 of the mirror replacement system 247. With a small articulation angle 210 or little obscuring of the observation area 242, the display of image data 515 may be dispensable. The larger the articulation angle 210 or the obscuring of the observation area 242, the more mirror replacement image data 516 is blended with the image data 515 to achieve an intuitive representation of the relevant lateral space 301, 302 and/or rear space 300.

The mirror replacement system 247 has a mirror replacement output device 265 and the output device 245 contains the mirror replacement output device 265. In other words, the mirror replacement output device 265 and the output device 245 show the same display or displays. The output device 245 is set up to output the image data 515 of the cameras 101, 102 and the mirror replacement image data 516 for this purpose.

The output device 245 is set up to simultaneously output image data 515 from the camera 101, 102 and from the reversing camera 110.

FIG. 9 shows a schematic representation of a multiple-unit vehicle combination 200a, in particular a utility vehicle combination 200b, according to an aspect of the disclosure. FIG. 9 is described with reference to FIG. 8. The differences between the embodiments of FIGS. 8 and 9 are described.

The mirror replacement system 247 contains a mirror replacement output device 265. The output device 245 and the mirror replacement output device 265 are different from each other. In other words, the mirror replacement output device 265 and the output device 245 contain different displays from each other. The output device 245 is set up to output the image data 515 of the cameras 101, 102, and the mirror replacement output device 265 is set up to output the mirror replacement image data 516.

FIG. 10 shows a schematic schedule of a method 400 according to an aspect of the disclosure. The method 400 is a method 400 for monitoring a rear space 300 and/or a lateral space 301, 302 for a multiple-unit vehicle combination 200a, in particular a utility vehicle combination 200b, including a trailer 250 with a camera 101, 102 arranged in the front area 254 of the trailer 250 for monitoring the rear space 300 and/or the lateral space 301, 302 and a tractor vehicle 240 with a mirror replacement system 247. Such a vehicle combination 200a, 200b is described with reference to FIGS. 7 to 9. FIG. 10 is described with reference to FIGS. 7 to 9.

The method 400 as shown in FIG. 10 includes: capturing 410 recognizability information 501 concerning the recognizability of the trailer 250, the rear space 300 and/or the lateral space 301, 302. In this context, the recognizability information 501 includes an articulation angle 210 and/or movement data 264 concerning a movement of the tractor vehicle 240 for determining the articulation angle 210. Alternatively or additionally, the recognizability information 501 includes mirror replacement image data 516 recorded by the mirror replacement system 247.

Determination 420 of display information 502 is carried out on the basis of the recognizability information 501. The display information 502 is determined depending on a predetermined condition 262 concerning the articulation angle 210. The display information 502 is determined depending on whether the front face 252 of the trailer 250 and/or which front face section 253 of the front face 252 is depicted in the mirror replacement image data 516.

An output 430 of a control signal 510 for the output of image data 515 from the camera 101, 102 to an output device 245 is carried out based on the display information 502.

It is understood that the foregoing description is that of the preferred embodiments of the invention and that various changes and modifications may be made thereto without departing from the spirit and scope of the invention as defined in the appended claims.

### REFERENCE SIGNS (PART OF THE DESCRIPTION)

| | |
|---|---|
| 101 | Camera |
| 102 | Camera |
| 103 | Mirror replacement camera |
| 104 | Mirror replacement camera |
| 110 | Reversing camera |
| 111 | Side camera |
| 112 | Front camera |
| 200a | Vehicle combination |
| 200b | Utility vehicle combination |
| 210 | Articulation angle |
| 240 | Tractor vehicle |
| 242 | Observation area |
| 243 | Control device |
| 245 | Output device |
| 246 | Driver cab |
| 247 | Mirror replacement system |
| 248 | Output interface |
| 249 | Communication interface |
| 250 | Trailer |
| 251 | Body |
| 252 | End face |
| 253 | Front face section |
| 254 | Front area |
| 260 | Data processing device |
| 262 | Predetermined condition |
| 264 | Motion data |
| 265 | Mirror replacement output device |
| 300 | Rear space |
| 301 | Left lateral space |
| 302 | Right lateral space |
| 305 | Detection area |
| 350 | Damage |
| 400 | Method |
| 410 | Capture |
| 420 | Determine |
| 430 | Output |
| 501 | Recognizability Information |
| 502 | Display information |
| 510 | Control signal |
| 515 | Image data |
| 516 | Mirror replacement data |
| L | Longitudinal axis |
| F | Direction of travel |

1. A method for monitoring at least one of a rear space and a lateral space for a multiple-unit vehicle combination including a trailer and a tractor vehicle, the trailer having a camera arranged in a front space of the trailer for monitoring at least one of the rear space and the lateral space of the trailer and the tractor vehicle having a mirror replacement system, the method comprising:
capturing recognizability information relating to a recognizability of at least one of the trailer, the rear space, and the lateral space;
determining display information on a basis of the recognizability information; and,
outputting a control signal for outputting image data from the camera to an output device based on the display information.

2. The method of claim 1, wherein the recognizability information includes at least one of movement data concerning an articulation angle and a movement of the tractor vehicle for determining the articulation angle.

3. The method of claim 2, wherein the display information is determined depending on a predetermined condition relating to the articulation angle.

4. The method of claim 1, wherein the recognizability information includes mirror replacement image data captured by the mirror replacement system.

5. The method of claim 4, wherein the display information is determined depending on whether a front end face of the trailer and/or which end face section of the front end face is depicted in the mirror replacement image data.

6. The method of claim 1, wherein the multiple-unit vehicle combination is a multiple-unit utility vehicle combination.

7. A computer program and/or a computer-readable medium, comprising instructions which, during execution of the program or the instructions by a computer, cause the computer to carry out the method of claim 1.

8. A control device for a multiple-unit vehicle combination including a tractor vehicle having a mirror replacement system and a trailer with a camera arranged in a front space of the trailer for monitoring at least one of a rear space and a lateral space, the control device comprising:
a processor;
a non-transitory computer readable medium having program code stored thereon;
said program code being configured, when executed by said processor, to:
capture recognizability information relating to a recognizability of at least one of the trailer, the rear space, and the lateral space;
determine display information on a basis of the recognizability information; and, output a control signal for outputting image data from the camera to an output device based on the display information.

9. The control device of claim 8, wherein the control device is a control device of the tractor vehicle.

10. The control device of claim 8, wherein the multiple-unit vehicle combination is a multiple-unit utility vehicle combination.

11. A trailer for a multiple-unit vehicle combination including the trailer and a tractor vehicle, the trailer comprising:
a camera arranged in a front space of the trailer for monitoring at least one of a rear space and a lateral space of the trailer;
a data processing device for transmitting image data to the tractor vehicle; and,
said data processing device being configured to receive a control signal from the tractor vehicle for the output of the image data from said camera to an output device.

12. A tractor vehicle for a multiple-unit vehicle combination including a trailer and the tractor vehicle, the trailer having a camera arranged in a front space of the trailer for monitoring at least one of a rear space and a lateral space of the trailer, the trailer further having a data processing device for transmitting image data to the tractor vehicle, the data processing device being configured to receive a control signal from the tractor vehicle for the output of the image data from the camera to an output device, the tractor vehicle comprising:
a mirror replacement system including said output device;
a control device including a processor and a non-transitory computer readable medium having program code stored thereon;
said program code being configured, when executed by said processor, to:
capture recognizability information relating to a recognizability of at least one of the trailer, the rear space, and the lateral space;
determine display information on a basis of the recognizability information; and,
output the control signal for outputting the image data from the camera to the output device based on the display information.

13. The tractor vehicle of claim 12, wherein said mirror replacement system has a mirror replacement output device; and, said output device is different from said mirror replacement output device.

14. The tractor vehicle of claim 12, wherein said mirror replacement system has a mirror replacement output device; and, said output device includes said mirror replacement output device.

15. The tractor vehicle of claim 12, wherein said output device is configured to simultaneously output the image data from the camera and from a reversing camera.

16. The tractor vehicle of claim 12, wherein said control device is configured to perform blending of the image data from said camera and of mirror replacement image data.

17. A multiple-unit vehicle combination comprising:
a trailer having a camera arranged in a front space of the trailer for monitoring at least one of a rear space and a lateral space of said trailer;
a tractor vehicle having a mirror replacement system including an output device;
said trailer further having a data processing device for transmitting image data to said tractor vehicle;
said data processing device being configured to receive a control signal from said tractor vehicle for the output of the image data from said camera to said output device;
said tractor vehicle further having a control device including a processor and a non-transitory computer readable medium having program code stored thereon;
said program code being configured, when executed by said processor, to:
capture recognizability information relating to a recognizability of at least one of the trailer, the rear space, and the lateral space;
determine display information on a basis of the recognizability information; and,
output the control signal for outputting the image data from the camera to said output device based on the display information.

18. The multiple-unit vehicle combination of claim 17 further comprising a communication interface for the transmission of information between said control device of said tractor vehicle and said data processing device of said trailer.

19. The multiple-unit vehicle combination of claim 17, wherein the multiple-unit vehicle combination is a multiple-unit utility vehicle combination.
